(19) United States
(12) Patent Application Publication
(10) Pub. No.: US 2019/0374899 A1
(43) Pub. Date: Dec. 12, 2019

(54) OILY SMOKE PURIFICATION DEVICE

(71) Applicant: Xinfu Tang, Dongguan (CN)

(72) Inventors: Xinfu Tang, Dongguan (CN); Peng Tang, Wugang (CN); Yansong Han, Dandong (CN); Jianjing Chen, Dongguan (CN); Jing Xia, Shenyang (CN); Guanqi Song, Songyuan (CN)

(21) Appl. No.: 16/550,282

(22) Filed: Aug. 26, 2019

(51) Int. Cl. B01D 50/00; B01D 47/02; B01D 45/04; B01F 3/04; B01F 5/06; F24C 15/20

(52) U.S. Cl. CPC B01D 50/004; B01D 47/025; F24C 15/2035; B01F 3/0446; B01F 5/0604; B01D 45/04

(57) ABSTRACT

An oily smoke purification device includes a holder, a main housing, a mixing mechanism, a filter and an exhaust fan. The holder is filled with purification solution, the exhaust fan is started to cause a negative pressure inside the main housing, oily smoke enters the purification solution from a gap between the holder and the main housing and is mixed with the purification solution under an action of the mixing mechanism to absorb dirt in the oily smoke into the purification solution, and the oily smoke is filtered by the filter to generate clean air which is sucked by the exhaust fan. The hazardous substance including oil, dust and other impurities in the contaminated air is filtered and the air is purified, thereby protecting the environments and ensuring the heath of people.

### FIELD OF THE INVENTION

The present invention relates to a field of oily smoke purification appliances, and more particularly to an oily smoke purification device capable of quickly exhausting contaminated air with oily smoke and steam produced in the kitchen.

### BACKGROUND OF THE INVENTION

Contaminated air mixed with oily smoke generated from food and gas generated from the cooker during a cooking process contains carbon monoxide, carbon dioxide, nitrogen oxides and benzopyrene, which are highly carcinogenic. If people inhale the contaminated air chronically, it will affect the health of the body and cause various diseases. Therefore, a range hood is widely used in the kitchen, which generally includes a simple hood cover to collect the exhaust air through the exhaust fan to the atmosphere, which will still pollute the surrounding environment however since the exhaust air is discharged without purification. With people's pursuit of healthy life and green life, the range hood of directly discharging of oily smoke is no longer desirable. Therefore, it is necessary to develop an improved device for purifying the contaminated air with oily smoke and steam.

### SUMMARY OF THE INVENTION

One objective of the present invention is to provide an oily smoke purification device which has simple structure and improved purification effect.

To achieve the mentioned above objectives, the present invention provides an oily smoke purification device, comprising a holder, a main housing, a mixing mechanism, a filter and an exhaust fan, wherein the holder is filled with purification solution, the main housing is installed in the holder, multiple notches are provided at a bottom of the main housing, the mixing mechanism is installed at a lower portion of the main housing, the filter is installed at an upper portion of the main housing, the exhaust fan is installed at a top of the main housing, the exhaust fan is started to cause a negative pressure inside the main housing, oily smoke enters the purification solution from a gap between the holder and the main housing and is mixed with the purification solution under an action of the mixing mechanism to absorb dirt in the oily smoke into the purification solution, and the oily smoke is filtered by the filter to generate clean air which is sucked by the exhaust fan.

Preferably, the mixing mechanism comprises an upper mixing plate and a lower mixing plate located below the upper mixing plate, multiple lower through holes are provided on the lower mixing plate, an upper through hole is provided at a middle of the upper mixing plate, the lower through holes and the upper through hole are staggered and non-overlapped, mixture of the oily smoke and the purification solution are sucked by the exhaust fan to enter the lower mixing plate and the upper mixing plate through the lower through holes and is exhausted from the upper through hole.

Preferably, one mixing mechanism consists of one lower mixing plate and one upper mixing plate, and 2-5 mixing mechanisms are included.

Preferably, the filter comprises an upper cone plate and a lower cone plate located below the upper cone plate, multiple air inlets are provided on the lower cone plate, multiple air vents provided at a middle of the upper cone plate, the air inlets and the air vents are staggered and non-overlapped, mixture of the oily smoke and the purification solution passes through the air inlets and enters between the lower cone plate and the upper cone plate to achieve water vapor separation, after the separation, clean air is exhausted from the exhaust fan, and liquid drops down.

Preferably, one filter is formed by one upper cone plate and one lower cone plate, and 2-5 filters are included.

Preferably, a waste tank is installed in the main housing and located between the mixing mechanism and the filter, a liquid level sensor is installed in the waste tank which is communicated with a drain duct, and waste liquid is discharged from the drain duct once the waste liquid is detected to reach a predetermined level.

Preferably, the purification solution is made of materials including jasmine 2-4 g, Eupatorium fortunei 2-4 g, radix aucklandiae 4-6 g, masson pine 13-17 g, mint 1-3 g, rose 2-4 g, and water 900-1100 mL.

More preferably, the purification solution is made of materials including jasmine 3 g, Eupatorium fortunei 3 g, radix aucklandiae 5 g, masson pine 15 g, mint 2 g, rose 3 g, water 1000 mL.

Preferably, the holder and the main housing are cylindrical.

In comparison with the prior art, after the exhaust fan is started to cause a negative pressure inside the main housing, the oily smoke/steam enters the purification solution from the gap between the holder and the main housing, which causes the oily smoke/steam and the purification solution to mix fully. As a result, the dirt including oil, dust and other impurities in the oily smoke/steam is absorbed into the purification solution and reaches to the filter together with the steam; through the filter, the clean air and the waste liquid are separated, the clean air then is sucked by the exhaust fan, while the waste liquid drops down into the waste tank. In such a way, the hazardous substance including oil, dust and other impurities in the contaminated air is filtered and the air is purified, thereby protecting the environments and ensuring the heath of people.

### BRIEF DESCRIPTION OF THE DRAWINGS

The accompanying drawings facilitate an understanding of the various embodiments of this invention. In such drawings:

FIG. 1 is a schematic view of an oily smoke purification device according to an embodiment of the present invention;

FIG. 2 is an exploded perspective view of an oily smoke purification device according to an embodiment of the present invention;

FIG. 3 is a perspective view of a mixing mechanism of the oily smoke purification device according to an embodiment of the present invention;

FIG. 4 is a perspective view of a filter of the oily smoke purification device according to an embodiment of the present invention; and

FIG. 5 is an oily smoke purification device according to a preferred embodiment of the present invention.

### DETAILED DESCRIPTION OF ILLUSTRATED EMBODIMENTS

The present invention will be described in detail below with reference to the accompanying drawings and preferred embodiments.

In the description of the invention, it should be noted that, terms “center”, “upper”, “lower”, “left”, “right”, “vertical”, “horizontal”, “inside”, “outside”, etc. which are used to indicate orientation or positional relationship shown in the drawings, only for the convenience of describing the present invention and simplifying the description. It is not intended or implied that the position or element referred to must have a particular orientation, is constructed and operated in a particular orientation, and thus is not to be construed as limiting the invention.

In the description of the invention, it should be noted that, unless specifically stated and limited, the term “install”, “connect”, shall be understood broadly, for example, it may be a fixed connection, a detachable connection, or an integral connection; it may be a mechanical connection or an electrical connection; it may be directly connected, or connected indirectly through an intermediate medium, or it can be an internal connection between two components. For persons skilled in the art, the specific meaning of the above terms in the present invention can be understood as the case may be.

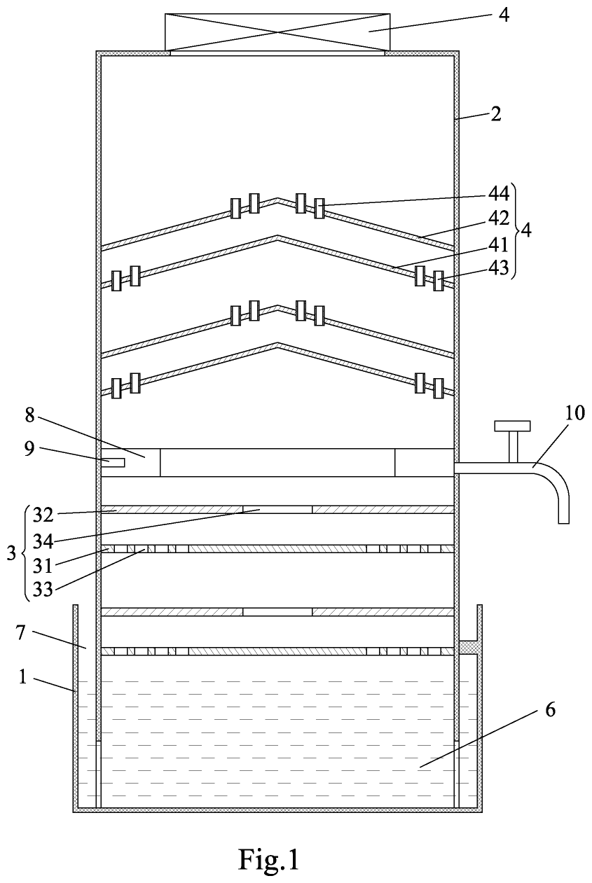

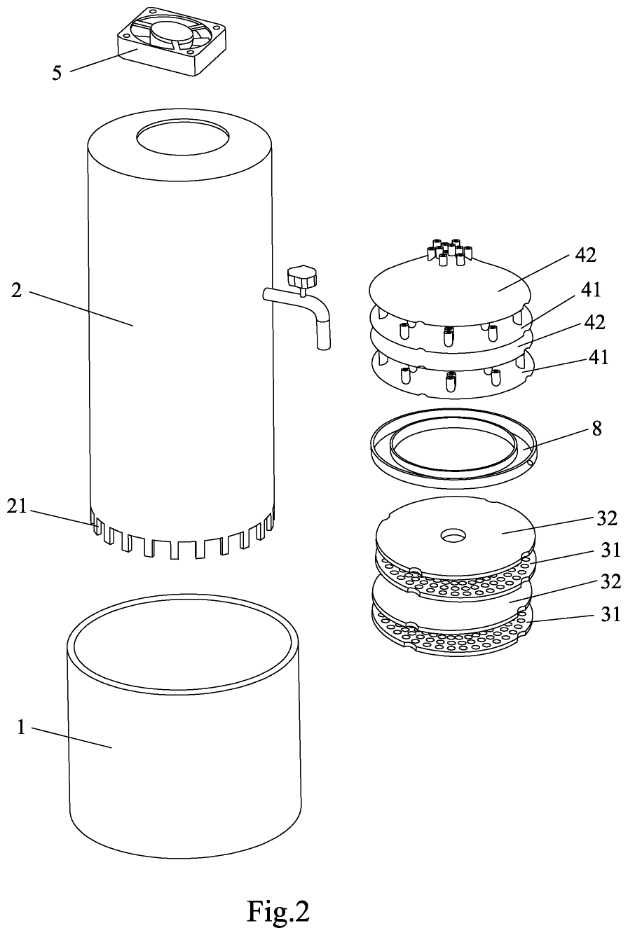

As illustrated in FIGS. 1 and 2, an oily smoke purification device includes a holder 1, a main housing 2, a mixing mechanism 3, a filter 4 and an exhaust fan 5. The holder 1 is filled with purification solution 6, the main housing 2 is installed in the holder 1, the holder 1 and the main housing 2 are cylindrical, and the main housing 2 is mounted on the holder 1 by a support or buckles, or the like. Multiple notches 21 are provided at a bottom of the main housing and distributed circumferentially along the central axis of the main housing 2. The mixing mechanism 3 is installed at a lower portion of the main housing 2, the filter 4 is installed at an upper portion of the main housing 2, and the exhaust fan 5 is installed at a top of the main housing 2. Under the normal status, the purification solution 6 in the holder 1 will not go into the mixing mechanism 3, and after the exhaust fan 5 is started to cause a negative pressure inside the main housing 2, the oily smoke/steam enters the purification solution from a gap between the holder 1 and the main housing 2, which causes the oily smoke/steam to mix with the purification solution to fully due to the mixing mechanism 3, under the extraction effect of the exhaust fan 5. As a result, the oily smoke is mixed with the purification solution fully under the action of the mixing mechanism 3, and the dirt including oil, dust and other impurities in the oily smoke/steam is absorbed into the purification solution and reaches to the filter 4 together with the steam; through the filter 4, clean air and waste liquid are separated, the clean air then is sucked by the exhaust fan 5, while the waste liquid drops down.

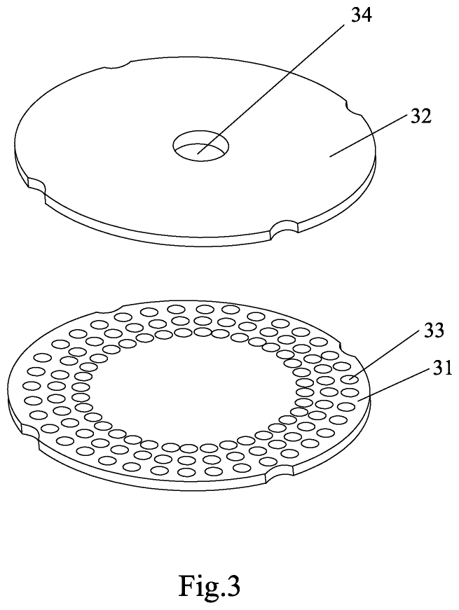

As illustrated in FIG. 3, the mixing mechanism 3 includes an upper mixing plate 32 and a lower mixing plate 31 located below the upper mixing plate 32. Multiple lower through holes 33 are provided at the lower mixing plate 31, an upper through hole 34 is provided at a middle of the upper mixing plate 32, the lower through holes 33 and the upper through hole 34 are staggered and non-overlapped. The mixture of the oily smoke/steam and the purification solution are sucked by the exhaust fan 5 to enter the lower mixing plate 31 and the upper mixing plate 32 through the lower through holes 33 and is then exhausted from the upper through hole 33, thereby achieve rolling and mixing. Preferably, one mixing mechanism 3 consists of one lower mixing plate 31 and one upper mixing plate 32, and 2-5 mixing mechanisms 3 are included in this embodiment. After rolling through 2-5 mixing mechanisms 3, the oily smoke and the purification solution are mixed fully.

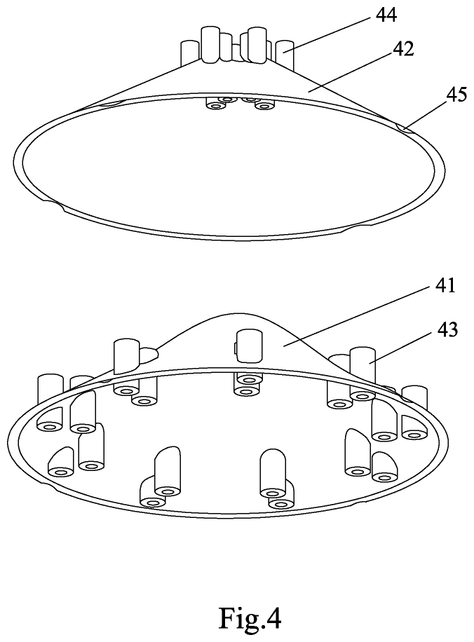

As shown in FIG. 4, the filter 4 includes a lower cone plate 41 and an upper cone plate 42 located below the upper cone plate 41, multiple air inlets 43 are provided on the lower cone plate 41, multiple air vents 44 provided at a middle of the upper cone plate 42, the air inlets 43 and the air vents 44 are staggered and non-overlapped. As a result, the mixture of the oily smoke and the purification solution passes through the air inlets 43 and enters between the lower cone plate 41 and the upper cone plate 42 to achieve water vapor separation under a principle of inertial collision. After the separation, clean air is exhausted from the exhaust fan, and the waste liquid drops down after reaching the notches 45 along the tilted surface of the lower cone plate 41 and the upper cone plate 42. Preferably, one filter 4 consists of one lower cone plate 41 and one upper cone plate 42, and 2-5 filters 4 are included in this embodiment.

Specifically, a waste tank 8 is installed in the main housing 2 and located between the mixing mechanism 3 and the filter 4, and a liquid level sensor 9 is installed in the waste tank 8 which is communicated with a drain duct 10. The waste liquid dropping from the filter 8 will drop into the waste tank 8, after the waste liquid reaches to a predetermined level which is detected by the liquid level sensor 9, the exhaust fan 5 is stopped, and the waste liquid will be discharged from the drain duct 10 by controlling a manual valve or an electromagnetic valve, without manual cleaning, which is convenient.

Specifically, the purification solution is made of materials including jasmine 2-4 g, Eupatorium fortunei 2-4 g, radix aucklandiae 4-6 g, masson pine 13-17 g, mint 1-3 g, rose 2-4 g, and water 900-1100 mL. Preferably, the purification solution is made of materials including jasmine 3 g, Eupatorium fortunei 3 g, radix aucklandiae 5 g, masson pine 15 g, mint 2 g, rose 3 g, water 1000 mL. The preparation method includes mixing the above materials and soaking for certain time, and filtering to obtain purification solution. Since the purification solution is made by plant preparations which are aromatous and refreshing. In such a way, the purification solution not only can purify the dust and oily smoke, but also can bring oil-free, dust-free gas to the air, which can refresh the brain and ensure the spirit of people.

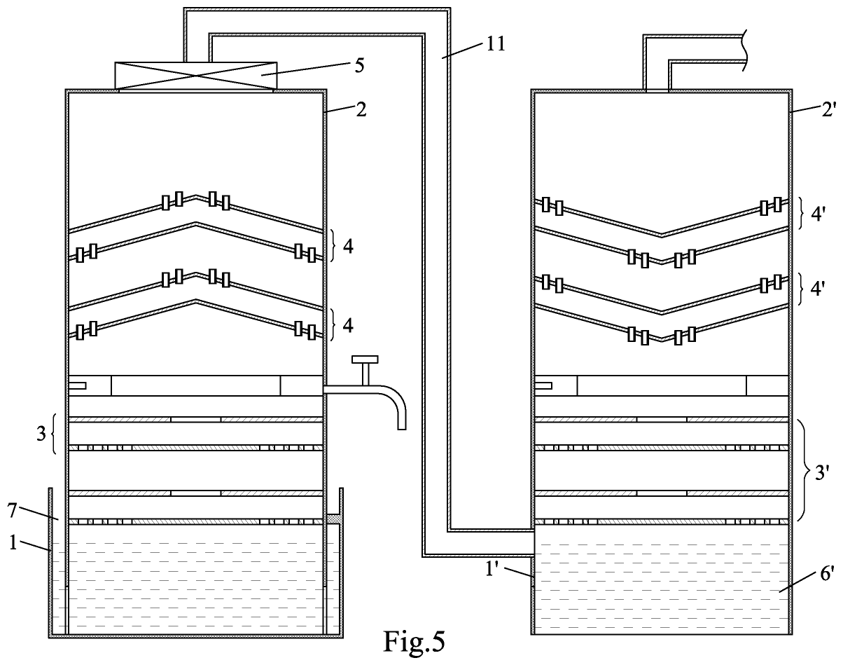

As a preferred embodiment, for enhancing the purification effect, the air pumped by the exhaust fan 5 can be accessed to another oily smoke purification device for twice purifications by using a duct 11. As shown in FIG. 5, specifically, the air from the exhaust fan 5 can be connected to the holder 1′ of the second oily smoke purification device to enter the purification solution 6′ to perform the second purification. More specifically, the structure of the second oily smoke purification device and the purification process are similar to the device mentioned above, and the differences are that, the filters 4′ in the second oily smoke purification device are inverted relatively to the filter 4 of the first oily smoke purification device, the air from the exhaust fan 5 is led into the purification solution 6′ directly, then passes through the mixing mechanisms 3 and the filters 4′, and finally is guided out of the second oily smoke purification device under the action of negative pressure. In such a way, the purification effect is improved. In this embodiment, the two devices are arranged in a horizontal direction, but also can be arranged in a vertical direction in other embodiments.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An oily smoke purification device, comprising a holder, a main housing, a mixing mechanism, a filter and an exhaust fan, wherein the holder is filled with purification solution, the main housing is installed in the holder, multiple notches are provided at a bottom of the main housing, the mixing mechanism is installed at a lower portion of the main housing, the filter is installed at an upper portion of the main housing, the exhaust fan is installed at a top of the main housing, the exhaust fan is started to cause a negative pressure inside the main housing, oily smoke enters the purification solution from a gap between the holder and the main housing and is mixed with the purification solution under an action of the mixing mechanism to absorb dirt in the oily smoke into the purification solution, and the oily smoke is filtered by the filter to generate clean air which is sucked by the exhaust fan.

2. The oily smoke purification device according to claim 1, wherein the mixing mechanism comprises an upper mixing plate and a lower mixing plate located below the upper mixing plate, multiple lower through holes are provided on the lower mixing plate, an upper through hole is provided at a middle of the upper mixing plate, the lower through holes and the upper through hole are staggered and non-overlapped, mixture of the oily smoke and the purification solution are sucked by the exhaust fan to enter the lower mixing plate and the upper mixing plate through the lower through holes and is exhausted from the upper through hole.

3. The oily smoke purification device according to claim 2, wherein one mixing mechanism consists of one lower mixing plate and one upper mixing plate, and 2-5 mixing mechanisms are included.

4. The oily smoke purification device according to claim 1, wherein the filter comprises an upper cone plate and a lower cone plate located below the upper cone plate, multiple air inlets are provided on the lower cone plate, multiple air vents provided at a middle of the upper cone plate, the air inlets and the air vents are staggered and non-overlapped, mixture of the oily smoke and the purification solution passes through the air inlets and enters between the lower cone plate and the upper cone plate to achieve water vapor separation, after the separation, clean air is exhausted from the exhaust fan, and liquid drops down.

5. The oily smoke purification device according to claim 4, wherein one filter is formed by one upper cone plate and one lower cone plate, and 2-5 filters are included.

6. The oily smoke purification device according to claim 1, wherein a waste tank is installed in the main housing and located between the mixing mechanism and the filter, a liquid level sensor is installed in the waste tank which is communicated with a drain duct, and waste liquid is discharged from the drain duct once the waste liquid is detected to reach a predetermined level.

7. The oily smoke purification device according to claim 1, wherein the purification solution is made of materials including jasmine 2-4 g, Eupatorium fortunei 2-4 g, radix aucklandiae 4-6 g, masson pine 13-17 g, mint 1-3 g, rose 2-4 g, and water 900-1100 mL.

8. The oily smoke purification device according to claim 7, wherein the purification solution is made of materials including jasmine 3 g, Eupatorium fortunei 3 g, radix aucklandiae 5 g, masson pine 15 g, mint 2 g, rose 3 g, water 1000 mL.

9. The oily smoke purification device according to claim 1, wherein the holder and the main housing are cylindrical.
